(19) United States
(12) Patent Application Publication
(10) Pub. No.: US 2011/0023872 A1
(43) Pub. Date: Feb. 3, 2011

(54) ENTERTAINING NOSE CLIP ASSEMBLY FOR DIAPER CHANGING

(76) Inventor: Rebecca Evans, Indianola, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/840,601

(22) Filed: Jul. 21, 2010

Related U.S. Application Data
(60) Provisional application No. 61/229,412, filed on Jul. 29, 2009.

(51) Int. Cl. A62B 18/02; A63H 33/00

(52) U.S. Cl. 128/201.18; 446/27

(57) ABSTRACT

A dual function nose clip assembly is provided for use by a person changing another person's diaper. The assembly includes a nose clip with opposite pads for pinching the diaper changer's nostrils closed and an ornamental or whimsical cover. The nose clip assembly minimizes or eliminates smelling of diaper odors by the diaper changer while simultaneously entertaining or distracting the diaper wearer while the diaper is being changed. A cover or ornamental piece disguises the nose clip and may substantially hide the nose clip from view by the diaper wearer. The natural or spring biased nose clip is maintained on the diaper changer's nose without the use of straps or elastic bands extending around their head.

### CROSS-REFERENCE TO RELATED APPLICATIONS

This application claims priority under 35 U.S.C. § 119 to provisional application Ser. No. 61/229,412 filed Jul. 29, 2009, herein incorporated by reference in its entirety.

### BACKGROUND OF THE INVENTION

Diaper changing can often be an unpleasant task due to the odors. Also, diaper changing is a two-handed task, which often becomes more difficult as the child grows older and wiggles more during diaper changing. With adults, it is often advantageous or desirable to keep the diaper changing job lighthearted.

While various nose clips are well known for pinching a person's nose, such as during swimming to prevent water from entering the nasal cavity, such clips are single function and do not provide entertainment or distraction to a child or adult during diaper changing.

Therefore, a primary objective of the present invention is the provision of a dual function nose clip which inhibits breathing of odors and entertains a child or adult during diaper changing.

Another objective of the present invention is the provision of an odor inhibiting and entertainment device having nose pads to close the nostrils and an ornamental cover to visually stimulate or distract a child or adult during diaper changing.

Still another objective of the present invention is the provision of an improved nose clip having a body with opposite left and right sides with a gap between the sides for receiving a wearers nose, and a clip embedded within the body with opposite pads disposed in opposite sides of the body so as to pinch a wearer's nostrils substantially closed.

Yet another objective of the present invention is the provision of an improved nose clip having a whimsical body design which substantially or wholly encloses a spring biased slip.

Another objective of the present invention is the provision of an improved nose clip having a body in the shape of an animal nose, a clown nose, or other shape which provides a visual focal point for a child or adult looking at the person wearing the nose clip during diaper changing.

Yet another objective of the present invention is the provision of an improved nose clip which substantially covers the wearer's nose.

Still another objective of the present invention is the provision of an improved nose clip which is free from neck straps.

Another objective of the present invention is the provision of an improved nose clip which can be opened by squeezing a cover surrounding the clip for positioning the clip onto a wearer's nose.

A further objective of the present invention is the provision of a nose clip for diaper changing which is easy and safe to use.

These and other objectives will become apparent from the following description of the invention.

### SUMMARY OF THE INVENTION

The present invention is directed towards a dual function nose clip for use during diaper changing to preclude the diaper changer from breathing obnoxious smells and to entertain or distract the diaper wearer during the diaper changing process so that the diaper wearer is less inclined to wiggle and squirm around. The device includes an ornamental or whimsical body with a nose clip embedded therein. The body can be squeezed between the diaper changer's thumb and finger to open the clip for placement on the changer's nose before the diaper changing process begins. The clip includes opposing pads to pinch the changer's nostrils closed. The pads are normally biased towards a closed position to facilitate nostril pinching. The body substantially covers or hides the diaper changer's nose and provides a visual focus point for the diaper wearer looking at the diaper changer. The body may be in the form of an animal nose, a clown nose, a butterfly, a bug, or other cute form. The clip does not require straps extending around the changer's neck.

### BRIEF DESCRIPTION OF THE DRAWINGS

FIG. 1 is a sketch showing one embodiment of the nose clip invention in use.

FIG. 2 is an exploded view showing the components of the embodiment shown in FIG. 1 in a disassembled state.

FIG. 3 is a view from the rear side of the assembled embodiment shown in FIG. 1.

FIG. 4 is a perspective view of another embodiment of the nose clip device of the present invention wherein the cover is in the shape of a dog nose.

FIG. 5 is an exploded view of the dog nose clip of FIG. 4.

FIG. 6 is a perspective view of a butterfly embodiment of the nose clip of the present invention.

FIG. 7 is a perspective view of another embodiment of the present invention wherein the clip includes one or more pictorial panels.

FIG. 8 shows another embodiment of the nose of the invention in the form of a cat nose.

FIG. 9 is another embodiment of a dog nose clip according to the present invention.

### DETAILED DESCRIPTION OF THE PREFERRED EMBODIMENT

The odor control nose clip assembly of the present invention is generally designated in the drawings by the reference numeral 10. The assembly includes a nose clip 12 having a pair of opposite pads 14 connected by a bridge 16 and an ornamental cover 18. The pads 14 are adapted to engage the exterior sides of a person's nose and close the nostrils to inhibit breathing through the nostrils. Thus, the pads 14 of the nose clip 12 eliminate or minimize the breathing of odors during diaper changing.

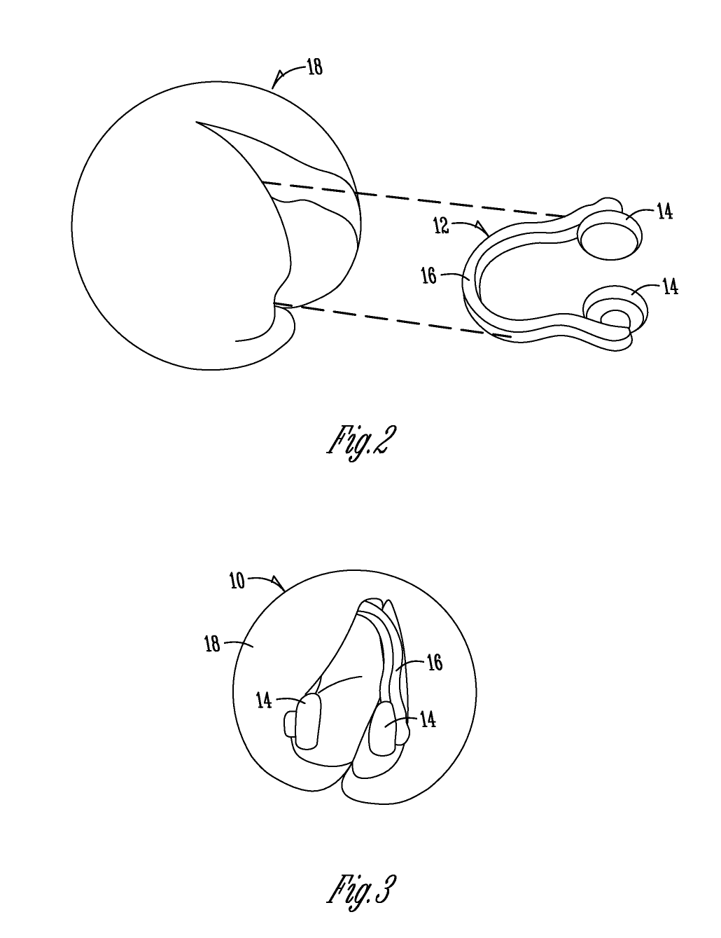

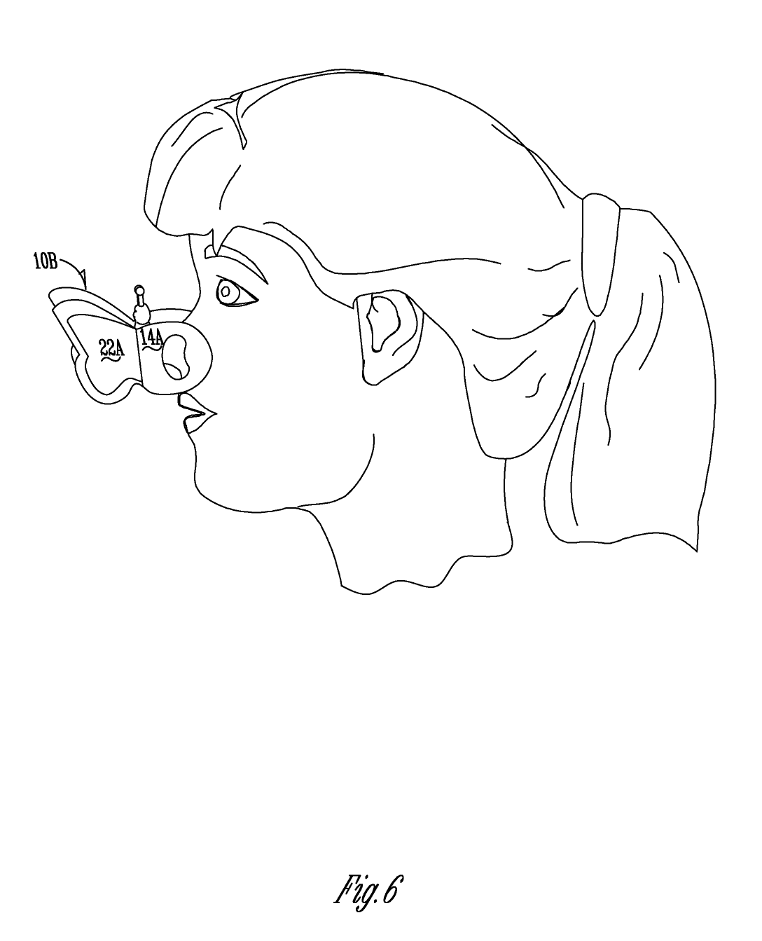

The nose clip 12 may be formed of a single resilient material, as seen in FIG. 2, so as to have an inherent bias, and thereby accommodate different sized noses. Alternatively, a spring hinge 20 may be provided between the pads 14, as seen in FIG. 5, so that the pads 14 can be opened for placement on the nose, and then closed by the bias of the spring. Tabs 22 may be provided opposite the pads 14 for squeezing between the diaper changer's thumbs and fore finger, opening the pads 14 against the bias of the spring. In each embodiment, the bridge 16 which interconnects the pads has a natural bias or spring bias such that the clip 10 can be quickly and easily put in place on the user's nose, and removed from the nose.

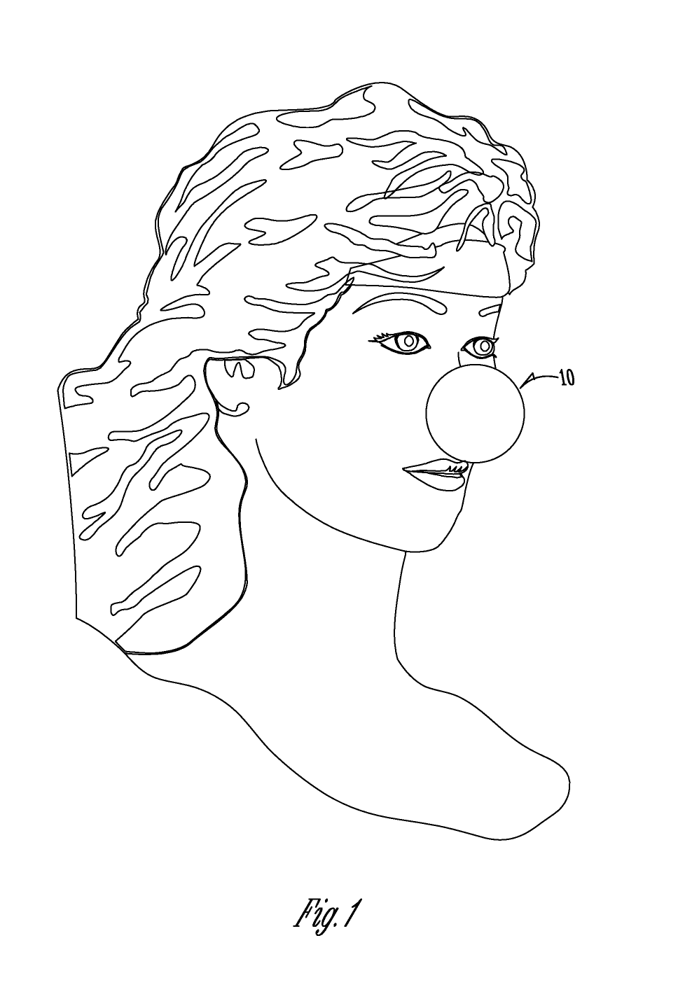

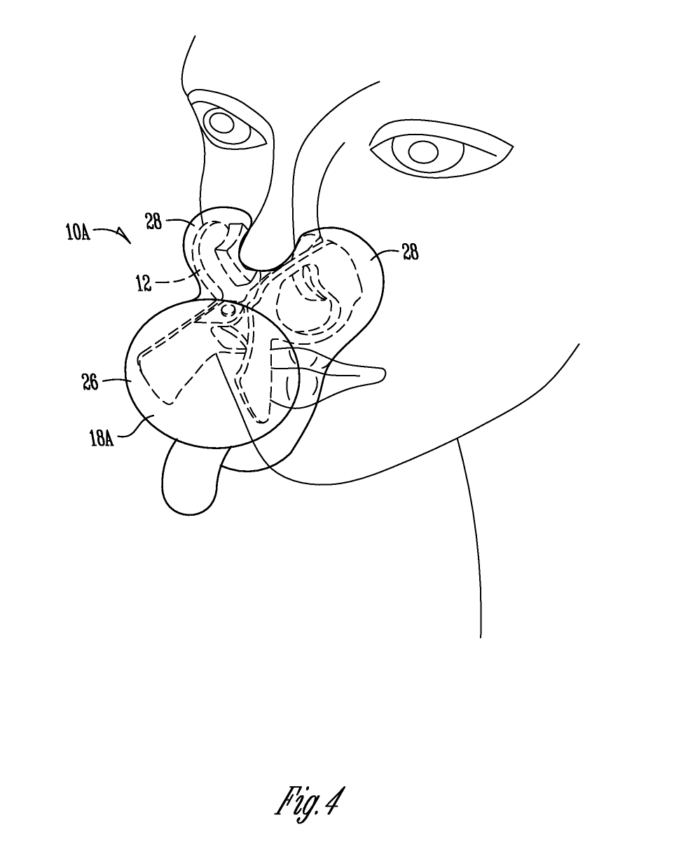

The cover 18 of the assembly 10 is connected to or integrally formed with the nose clip 12. The cover may be a whimsical or ornamental design which will attract a diaper wearer so as to entertain and/or distract a child or adult while his/her diaper is being changed. For example, in FIGS. 1-3, the cover is shown to be in the form of a clown's nose. The nose cover 18 may be a foam material, with the nose clip 12 embedded therein so that the nose clip 12 can be quickly and easily slid onto the changer's nose before changing the diaper. The cover 18 substantially hides the nose clip 12 from the view of the diaper wearer.

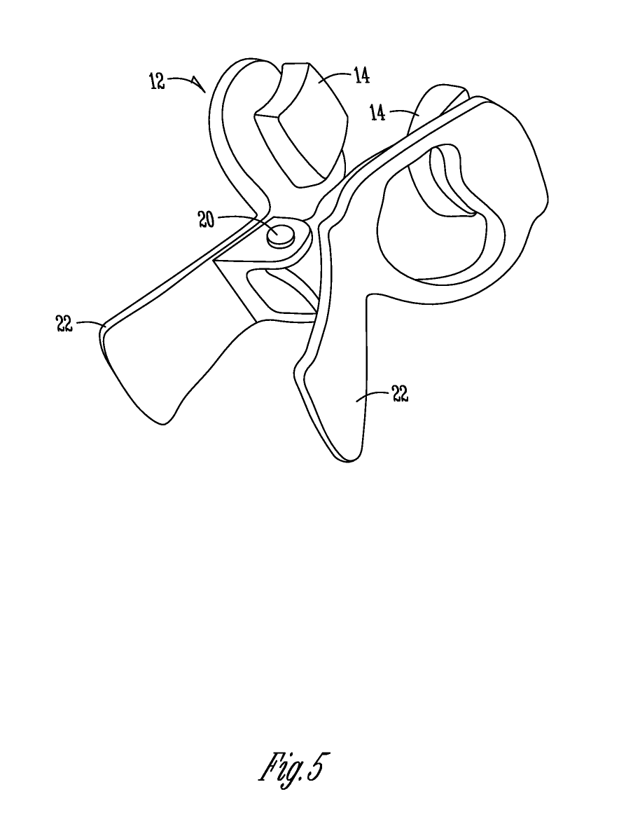

FIG. 4 shows a nose clip assembly 10A wherein the cover 18A is in the form of a dog nose. The dog nose is preferably made of a soft fabric or material and may be partially filled with batting, foam or other padding. The dog nose cover 18A enclosed the clip 12, with the tabs residing in the tip or front 26 of the nose 18A and the pads 14 residing in the opposite sides 28 of the nose 18A. A gap exists between the sides 28 for receiving the diaper changer's nose when the tip 26 is pinched to open the sides 28. The cover 18A may fully or partially enclose the clip 12.

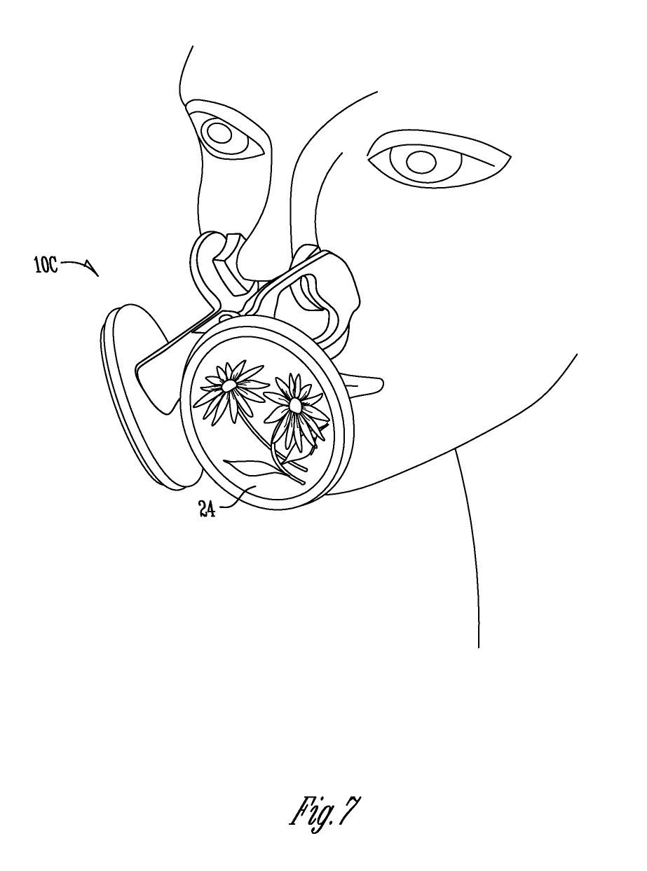

FIG. 6 shows an ornamental butterfly nose clip assembly 10B having wings which may be brightly colored to visually stimulate the child. The wings of the butterfly clip may include upper and lower portions, with the lower portions forming the pads 14A for engaging the changer's nose, and the upper portions forming the tabs 22A being adapted to be squeezed by the diaper changer to open the pads against a spring 20 in the body of the butterfly assembly 10A.

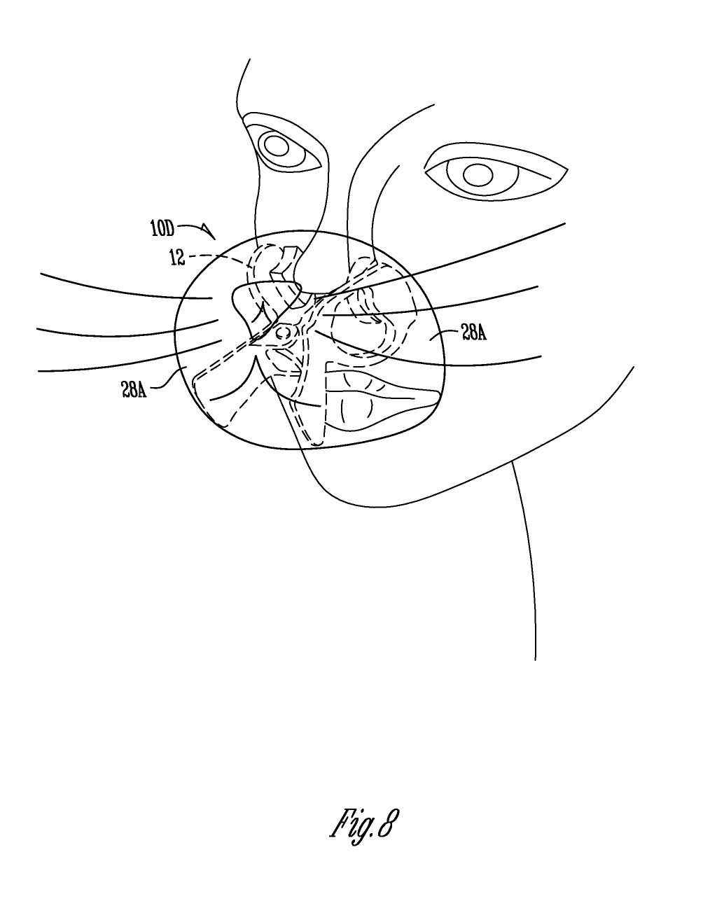

FIG. 7 shows a nose clip assembly 10C wherein the cover has one or more front panels or projection 24 having a sticker or other brightly colored picture thereon, so as to obtain the attention of the diaper wearer when the diaper is being changed. The panel 24 may also include a light-hearted sticker or note for reading by an adult diaper wearer.

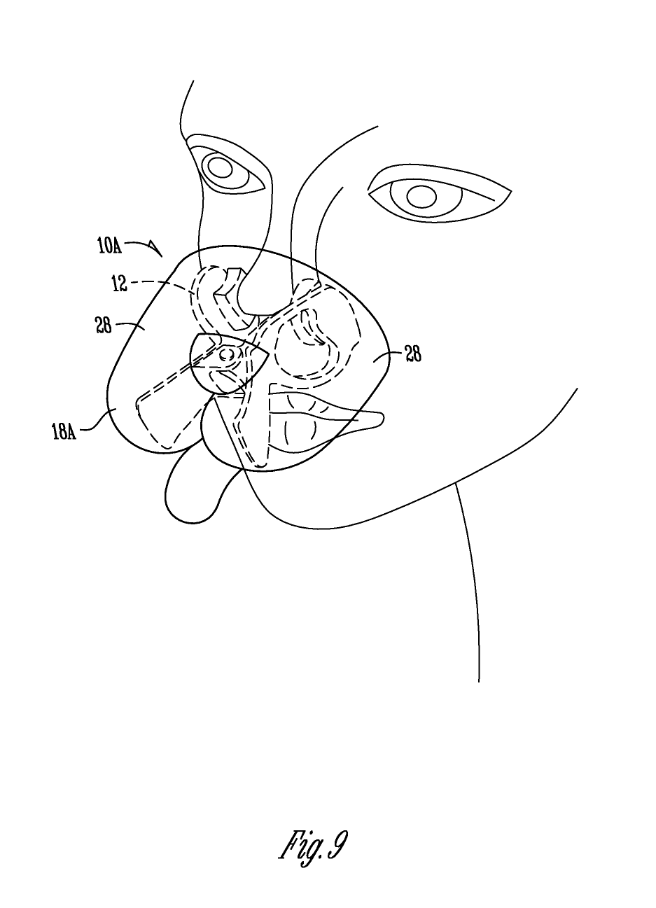

FIG. 8 shows the nose clip in the form of a cat nose 10D.

Other embodiments for the cover include animal noses, such as pigs, elephants, and the like. The nose clip assembly may also include a cover with antennae, eyes and/or other whimsical features, so as to form an alien creature or other entertaining character.

The nose clip assembly of the present invention does not include any straps to extend around the wearer's head or neck. The assembly is sufficiently large so as to be easy to find in a diaper bag, and so as to prevent any choking hazard if played with by a child.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. An odor inhibiting and entertainment nose clip assembly for wearing by a person changing diapers, comprising:
a nose clip having opposite pads to engage the exterior sides of a person's nose to close the nostrils to inhibit breathing of odors;
an ornamental piece on the clip to visually entertain a diaper wearer while changing diapers.

2. The assembly of claim 1 wherein the ornamental piece hides the clip from the diaper wearer.

3. The assembly of claim 1 wherein the pads are spring biased.

4. The assembly of claim 1 further comprising a bridge connecting the pads.

5. The assembly of claim 3 wherein the bridge is resilient.

6. The assembly of claim 3 wherein the bridge includes a spring to normally bias the pads to a closed position.

7. The assembly of claim 1 wherein the ornamental piece is selected from a group consisting of a clown nose, a butterfly, and an animal nose.

8. The assembly of claim 1 wherein the device is free of straps extending around the person's head.

9. The assembly of claim 1 wherein the ornamental piece substantially surrounds the nose clip.

10. An improved nose clip assembly, comprising:
a body having opposite left and right sides with a gap between the sides for receiving a wearer's nose; and
a clip embedded within the body and having opposing pads disposed in the opposite sides of the body, the pads being biased to pinch the wearer's nostrils substantially closed.

11. The improved nose clip assembly of claim 10 wherein the body is in the shape of an animal nose.

12. The improved nose clip assembly of claim 10 wherein the clip is substantially enclosed by the body.

13. The improved nose clip assembly of claim 10 wherein the body is a clown nose.

14. The improved nose clip assembly of claim 10 wherein the body is a soft material.

15. The improved nose clip assembly of claim 10 wherein the body substantially covers the wearer's nose.

16. The improved nose clip assembly of claim 10 wherein the clip includes a spring to bias the pads toward a closed position.

17. A method of changing diapers, comprising:
placing a nose clip on a diaper changer's nose to close the nostrils before changing a diaper on a diaper wearer;
entertaining the wearer with a cover on the nose clip; and
maintaining the changer's hands free of the nose clip and the cover while changing the diaper.

18. The method of claim 17 further comprising obscuring the changer's nose from view by the diaper wearer with the cover.

19. The method of claim 17 further comprising inserting the clip into the cover.

20. The method of claim 17 further comprising maintaining the clip and cover free from straps extending around the changer's neck.

21. The method of claim 17 further comprising opening the clip by squeezing the cover so as to position the clip and cover onto the changer's nose.
